(19) United States
(12) Patent Application Publication
(10) Pub. No.: US 2002/0151276 A1
(43) Pub. Date: Oct. 17, 2002

(54) Wireless communication device and method therefor

(76) Inventor: Osamu Ito, Tokyo (JP)

Correspondence Address: COOPER & DUNHAM LLP, 1185 Avenue of the Americas, New York, NY, 10036, US

(21) Appl. No.: 10/076,830

(22) Filed: Feb. 15, 2002

(30) Foreign Application Priority Data
Feb. 22, 2001 (JP) P2001-047304

(51) Int. Cl. H04Q 7/24

(52) U.S. Cl. 455/41; 455/412; 370/338

(57) ABSTRACT

A wireless communication device which is installed in host equipment and which performs wireless communication with other communication equipment is provided. The wireless communication device includes a memory for storing data; a wireless communication portion for transmitting and receiving data to and from the other communication equipment over a wireless communication network; and a control portion for controlling input and output of data between the wireless communication portion and the memory and between the wireless communication portion and the host equipment. Upon receiving designated-address information for the memory from the host equipment, the control portion writes data received from the other communication equipment through the wireless communication portion into the designated address or reads data to be transmitted to the other communication equipment through the wireless communication portion from the designated address.

### BACKGROUND OF THE INVENTION

1. Field of the Invention

The present invention relates to a wireless communication device that transmits and receives data to and from other communication equipment over a wireless communication network and to a method therefor.

2. Description of the Related Art

In recent years, in the art of wireless LAN (local area network) systems, systems incorporating Bluetooth have been under development. The Bluetooth system uses radio waves in the 2.4 GHz band, and performs transmission and reception of data between two or more pieces of equipment by processing in accordance with frequency hopping.

The Bluetooth system is designed to achieve dedicated wireless (RF) networking among a plurality of personal computers and/or devices using a wireless communication technology, and is being jointly developed by corporations in, for example, computer, electrical communication, and networking industries. Five companies from Japan, Europe, and the U.S. have joined a Bluetooth SIG (special interest group) to standardize the Bluetooth system. This Bluetooth system enables a notebook computer, PDA (personal digital assistant), or portable telephone to share information or various services with a personal computer through wireless communication, which can eliminate the need for messy cable connections.

A short-range wireless communication network incorporating the Bluetooth system may include multiple pieces of host equipment. The host equipment can perform wireless communication with other communication equipment through the short-range wireless communication network. Such wireless communication is performed through a wireless communication device installed in each piece of host equipment.

The aforementioned wireless communication device complies with the specifications of existing memory cards that may be installed in the host equipment or the like. A memory card may be a portable semiconductor memory device which stores data generated by the host equipment or the like or which stores data that is transmitted and received between the host equipment and the other communication equipment. The wireless communication device described above is configured by adding a wireless communication capability to an existing memory card. Thus, the wireless communication device makes it possible to carry data that is stored during wireless communication, thus allowing more effective use of the data.

When the host equipment in which the wireless communication device having such a memory card specification is installed performs wireless communication with other communication equipment over a wireless communication network, data is input and output between the host equipment and the communication equipment, between the host equipment and the wireless communication device, and between the wireless communication device and the communication equipment. Among these, to allow data to be communicated with the other communication equipment through the wireless communication device installed in the host equipment, it is necessary to be able to input and output data between the wireless communication device and the communication equipment.

However, the control of data input to and output from the wireless communication device is performed by the host equipment. Thus, when the wireless communication device transmits data to the communication equipment, the data must first be output to the host equipment from the wireless communication device and then must be transmitted from the host equipment to the communication equipment. When the wireless communication device receives data from the communication equipment, data from the communication equipment must first be received by the host equipment and then must be output from the host equipment to the wireless communication device. Thus, for data communication between the wireless communication device and the communication equipment, it is necessary to have data input and output to and from the host equipment.

### SUMMARY OF THE INVENTION

Accordingly, the present invention has been proposed in view of the foregoing situation, and an object thereof is to provide a wireless communication device and a wireless communication method which allow direct data communication with external communication equipment without inputting and outputting data to and from host equipment.

To this end, according to a first aspect of the present invention, there is provided a wireless communication device which is installed in host equipment and which performs wireless communication with other communication equipment. The wireless communication device includes a memory for storing data; a wireless communication portion for transmitting and receiving data to and from the other communication equipment over a wireless communication network; and a control portion for controlling input and output of data between the wireless communication portion and the memory and between the wireless communication portion and the host equipment. Upon receiving designated-address information for the memory from the host equipment, the control portion writes data received from the other communication equipment through the wireless communication portion into the designated address or reads data to be transmitted to the other communication equipment through the wireless communication portion from the designated address.

According to the wireless communication device of the present invention, since an address in the memory is designated by the host equipment prior to wireless communication, data can be directly communicated with external equipment, at the time of wireless communication, without inputting and outputting the data to and from the host equipment.

According to a second aspect of the present invention, there is provided a wireless communication method for a wireless communication device which is installed in host equipment and which includes a wireless communication portion for transmitting and receiving data to and from other communication equipment over a wireless communication network and a memory for storing data. The wireless communication method includes a step of reading data stored in a designated address and transmitting the data to the other communication equipment upon receipt of designated-address information for the memory from the host equipment; and a step of writing data received from the other communication equipment into a designated address upon receipt of designated-address information for the memory from the host equipment.

According to the wireless communication method of the present invention, since an address in the memory is designated by the host equipment prior to wireless communication, data can be directly communicated with external equipment, at the time of wireless communication, without inputting and outputting the data to and from the host equipment.

### BRIEF DESCRIPTION OF THE DRAWINGS

FIG. 1 is a schematic view illustrating a network including a wireless communication device according to the present invention;

FIG. 2 is a block diagram illustrating processes for writing data that is received from communication equipment and for reading data to be transmitted to the communication equipment, according to the wireless communication device of the present invention;

FIGS. 3A and 3B are an external front view and an external back side view, respectively, illustrating the wireless communication device according to the present invention.

FIG. 4 is a front view illustrating terminals that constitute a signal input/output portion of the wireless communication device according to the present invention;

FIG. 5 is a flow diagram illustrating first processing of a controller, a wireless I/F, and a host I/F, when data that is received from the communication equipment is written into the memory;

FIG. 6 is a flow diagram illustrating second processing of the controller, the wireless I/F, and the host I/F, when data that is received from the communication equipment is written into the memory;

FIG. 7 is a flow diagram illustrating first processing of the controller, the wireless I/F, and the host I/F, when data to be transmitted to the communication equipment is read from the memory; and

FIG. 8 is a flow diagram illustrating second processing of the controller, the wireless I/F, and the host I/F, when data to be transmitted to the communication equipment is read from the memory.

### DESCRIPTION OF THE PREFERRED EMBODIMENT

An embodiment of the present invention will now be described in detail with reference to the accompanying drawings.

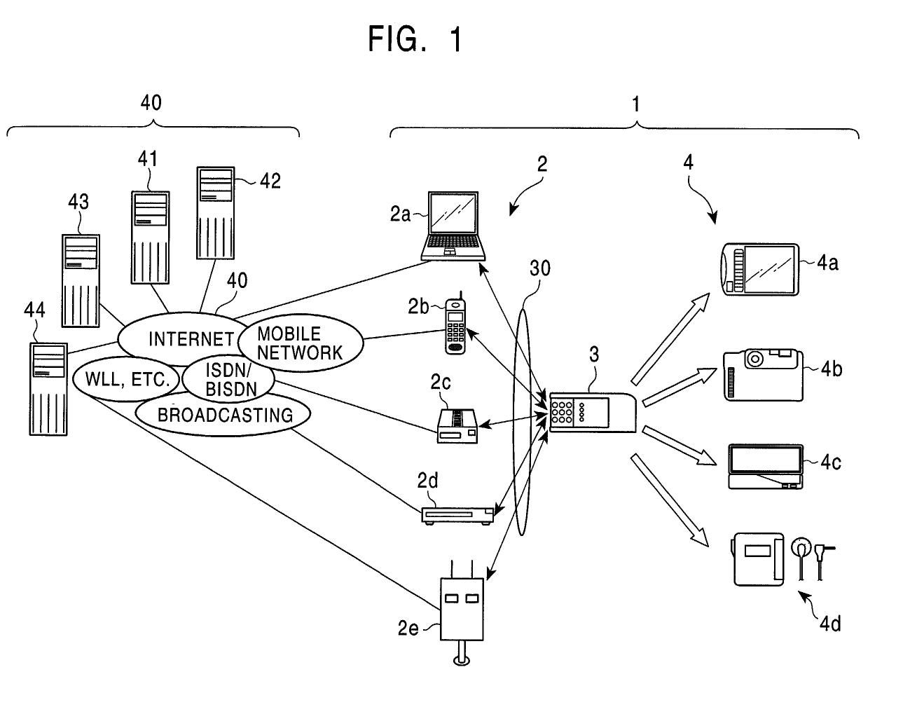

The present invention is applied to, for example, a LAN (local area network) system 1 configured as shown in FIG. 1.

The wireless LAN system 1 shown in FIG. 1 includes communication equipment 2 (2a to 2e) that transmits and receives data to and from a public communication network 40 such as the Internet; host equipment 4 (4a to 4d) that transmits and receives packets over a short-range wireless communication network 30; and a wireless communication device 3 that is installed in the host equipment.

The wireless LAN system 1 incorporates the Bluetooth system in which data communication between the communication equipment 2 (2a to 2e) that serves as a gateway and the host equipment 4 (4a to 4e) is performed through the wireless communication device 3 installed in the host equipment 4 (4a to 4e).

Bluetooth is an alias for a short-range wireless communication technology whose standardization started to be promoted by five companies from Japan, Europe, and the U.S. in May 1998. In the Bluetooth system, data is communicated at a maximum data transmission rate of 1 Mbps (721 Kbps in practice) and travels a maximum transmission distance of about 10 meters thereby forming a short-range wireless communication network. In the Bluetooth system, 79 channels each having a bandwidth of 1 MHz are set aside in the ISM (industrial scientific medical) frequency band of 2.4 GHz, which can be used without authorization, and frequency hopping spread spectrum technology in which the channels are switched 1,600 times per second is employed to transmit and receive radio waves to and from the host equipment 4 (4a to 4d).

Each piece of host equipment included in the short-range wireless communication network, which incorporates the Bluetooth system, employs a slave/master system. Thus, the host equipment is divided into master equipment that determines a pattern of frequency hopping and slave equipment that communicates with and is controlled by the master equipment, depending on contents to be processed. Each piece of master equipment can communicate data with seven pieces of slave equipment at a time. A sub-net that includes a total of eight pieces of equipment, that is, one unit of master equipment and seven units of slave equipment, is called a “piconet”. The host equipment 4, which is included in the wireless LAN system, designated as slave equipment, can serve as slave equipment for two or more piconets at a time.

The wireless communication device 3 is installed in the host equipment 4. The host equipment 4 is a device operated by a user. Examples of the host equipment 4 include a PDA (personal digital assistant) 4a, a digital camera 4b, a mail processing terminal 4c, and an EMD (electronic music distribution) terminal 4d.

The communication equipment 2 performs wireless communication with the wireless communication device 3 over the short-range wireless communication network 30. The communication equipment 2 is also connected to the public communication network 40 to serve as a gateway for communication between the wireless communication device 3 and the public communication network 40.

Example of the communication equipment 2 include a personal computer 2a that is provided with a modem or the like for connection with the public communication network 40; a portable telephone 2b incorporating the cdmaOne (code-division multiple access) system or the W-CDMA (wideband code division multiple access) system; a TA (terminal adapter)/modem 2c; a STB (set top box) 2d; and a semi-public system 2e such as a base station for communication between the wireless communication device 3, which complies with the Bluetooth system, and the public communication network 40.

The public communication network 40 provides various types of information in response to access from the communication equipment 2 or the like and serves as a gateway that transmits and receives data to and from various units of communication equipment.

Examples of the public communication network 40 include the Internet to which the personal computer 2a is connected through a telephone line; a mobile communication network that is connected with the portable telephone 2b, an ISDN (integrated services digital network) or a broadband ISDN that is connected with the TA/modem 2c; a satellite communication/broadcast network that is connected with the STB 2d; and a WLL (wireless local loop) that is connected with the semi-public system 2e.

The public communication network 40, which includes the internet service network, is connected with an information-providing server 41, an electronic mail server 42, an EMD server 43, a community server 44, and the like.

The information-providing server 41 manages Internet information. The information-providing server 41 receives a request from the host equipment 4 through the wireless communication device 3 and the communication equipment 2, and transmits information in accordance with the request to the host equipment 4 through the communication equipment 2 and the wireless communication device 3. The electronic mail server 42 manages electronic mail and transmits and receives electronic mail to and from the host equipment 4 through the communication equipment 2 and the wireless communication device 3. The EMD server 43 manages music-providing services and transmits music information to the EMD terminal 4d of the host equipment 4 through the communication equipment 2 and the wireless communication device 3. The community server 44 manages downloading services of town information and/or news information, and transmits the information to, for example, the digital camera 4b of the host equipment 4 through the communication equipment 2 and the wireless communication device 3. The community server 44 also manages, for example, uploading of information from the host equipment 4.

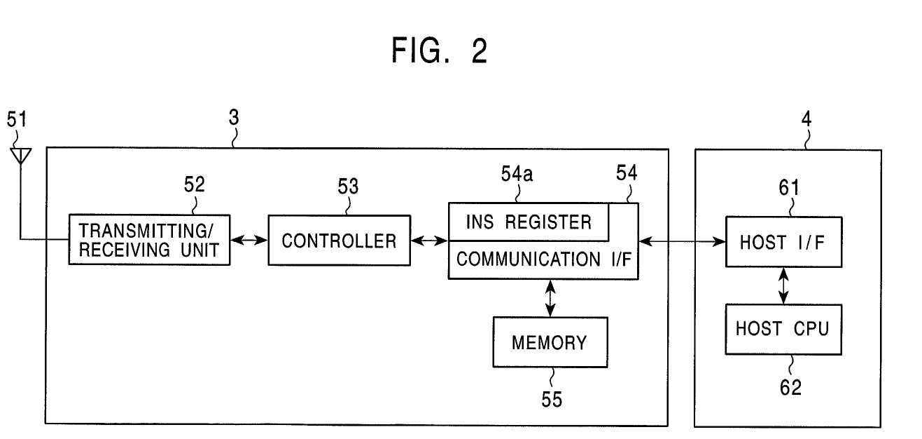

Next, the transmission and reception of data between the communication equipment 2 and the wireless communication device 3 installed in the host equipment 4 will be described with reference to FIG. 2.

Referring now to FIG. 2, the wireless communication device 3 includes an antenna 51, a transmitting/receiving unit 52, a controller 53, a communication I/F 54, and a memory 55.

The antenna 51 is used for outputting and/or detecting, for example, a signal in the 2.4 GHz band (2.402 GHz to 2.480 GHz) and transmits and receives a radio signal to and from the communication equipment 2 over the short-range wireless communication network 30. The antenna 51 transmits data from the transmitting/receiving unit 52 to the communication equipment 2 included in the short-range wireless communication network 30 or other equipment. The antenna 51 also receives data from the communication equipment 2 over the short-range wireless communication network 30 and outputs the data to the transmitting/receiving unit 52.

The transmitting/receiving unit 52 serves to transmit and receive, for example, a signal in the 2.4 GHz band in accordance with the Bluetooth system. One end of the transmitting/receiving unit 52 is connected to the antenna 51 and the other end is connected to the controller 53. The transmitting/receiving unit 52 inputs and outputs data to and from the antenna 51 and the controller 53. When transmitting data from the antenna 51, the transmitting/receiving unit 52 converts digital data input from the controller 53 into analog data, and performs primary modulation thereon in accordance with a sequence of 0s and 1s of the digital data. The transmitting/receiving unit 52 then sends out the resulting data over carrier waves in the 2.4-GHz band. The carrier waves have variable frequencies that are set for individual data transmissions (slots), and are continuously switched by frequency hopping. Further, upon input of a signal of analog data that is received by the antenna 51, the transmitting/receiving unit 52 converts the analog data into digital data by performing processes opposite to those described above, and outputs the data to the controller 53.

The transmitting/receiving unit 52 transmits and receives data alternately for each slot. At the receiving slot, 2.4-GHz carrier waves are removed from signals received by the antenna 51, the resulting signals are modulated, and then digital data of a sequence of 0s and 1s is retrieved. The frequencies of the carrier waves to be removed vary constantly due to the frequency hopping. The hopping sequences, however, are known depending on the other end of the communication, and are determined by the master equipment of the master/slave system.

The controller 53, for example, controls transmission and reception of data between the communication equipment 2 and the wireless communication device 3. One end of the data controller 53 is connected to the transmitting/receiving unit 52, and the other end is connected to the communication I/F 54. In response to an address-designation notification notifying that an address is designated by the communication I/F 54, the controller 53 transmits and receives data to and from the communication equipment 2 through the transmitting/receiving unit 52. The controller 53 also controls data transfer to and from the communication I/F 54.

The communication I/F 54 is connected to the controller 53, is connected to the memory 55, and is also connected to the host equipment 4. The communication I/F 54 sends and receives data to and from the controller 53, and also writes data into a designated address in the memory 55 or reads data from a designated address in the memory 55. The communication I/F 54 also includes an INT register for inputting and outputting data.

The memory 55 may be a flash memory, and stores data to be communicated with the communication equipment 2 into a designated address. Data writing into or data reading from the memory 55 is performed by the communication I/F 54.

The host equipment 4 includes a host I/F 61 and a host CPU 62.

The host I/F 61 outputs the address of data to be read from the memory 55 or an address for data to be written into the memory 55 to the wireless communication device 3 in a packet format. (Those addresses will be referred to as “designated-address information” hereinafter.) The designated-address information is generated by the host CPU 62 and is input to the host I/F 61. The host I/F 61 inputs and outputs data to be communicated with the communication equipment 2 to and from the communication I/F 54 in a packet format. The host I/F 61 also receives an end-of-data-transfer notification from the wireless communication device 3.

Equipment which transmits and receives data to and from the host equipment 4 is not limited to the communication equipment 2, and thus may be a wireless communication device that is installed in other host equipment included in the wireless LAN system 1.

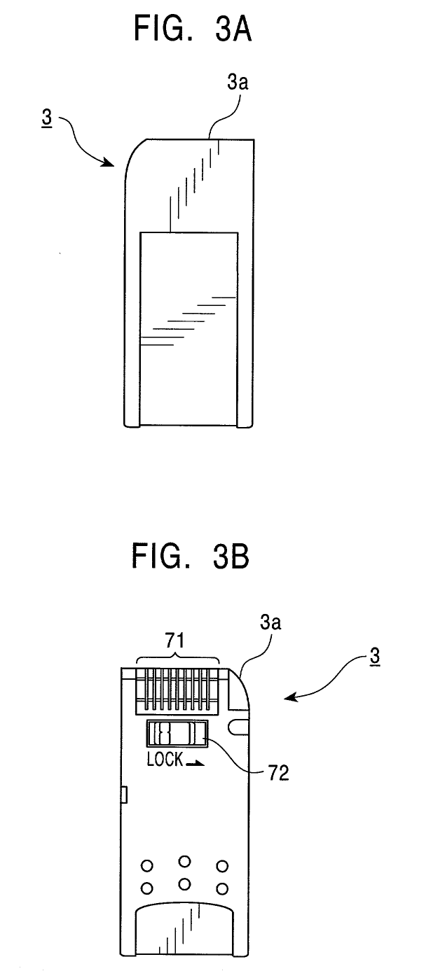

The external features of the wireless communication device 3 will now be described with reference to FIGS. 3A and 3B. The wireless communication device 3 complies with the specifications of, for example, a known semiconductor memory card, and has, for example, a width of 21.5 mm, a length of 50.0 mm, and a thickness of 2.8 mm. The wireless communication device 3 may be installed in the host equipment 4 with one end 3a being inserted in a connector slot of the host equipment 4, so as to input and output data and address information.

On the reverse surface of the wireless communication device 3, as shown in FIG. 3B, a signal input/output portion 71 is provided at one end 3a and an erasure protector 72 for switching between enabling and disabling of erasure of data stored in the memory 55 is also provided. The signal input/output portion 71 has ten terminals, and sends and receives addressing information and the like to and from the host equipment 4 through the terminals.

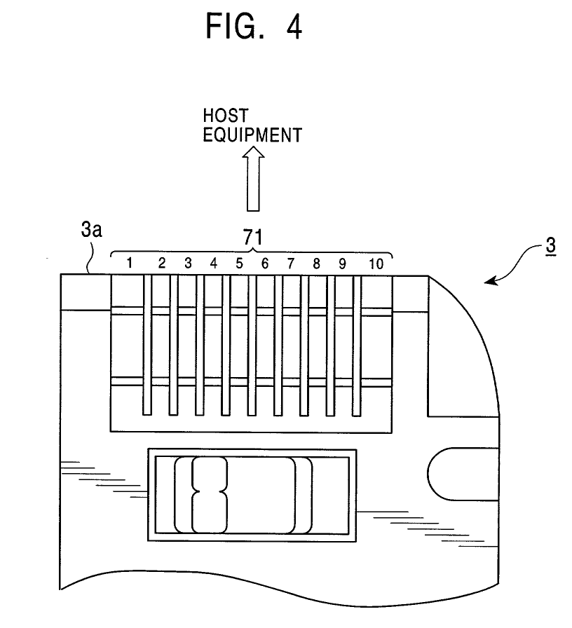

As shown in the enlarged view of FIG. 4, the signal input/output portion 71 has terminal numbers 1 to 10. Referring to Table 1 below, each terminal of the signal input/output portion 71 is given a function of input and/or output for each terminal number.

TABLE 1

| No. | Pin Name | I/O | Pin Function |
|---|---|---|---|
| 1 | VSS | | VSS |
| 2 | BS | I | Serial Protocol Pass |
| | | | State Signal |
| 3 | VCC | I | VCC |
| 4 | SDIO | I/O | Serial Protocol Data |
| | | | Signal |
| 5 | A0 | I/O | Audio Data Signal 0 |
| 6 | INS | O | Mounting/Dismounting |
| | | | detection terminal |
| 7 | A1 | I/O | Audio Data Signal 1 |
| 8 | SCLK | I | Serial Protocol |
| | | | Clock Signal |
| 9 | VCC | I | VCC |
| 10 | VSS | | VSS |

As shown in Table 1, the signal input/output portion 71 has a terminal BS, with terminal number 2, to which a signal is fed from the host equipment 4 in accordance with a serial protocol; a terminal SDIO with terminal number 4; and a terminal SCLK with terminal number 8. Those terminals with terminal numbers 2, 4, and 8 are each a physical serial interface. The terminals with terminal numbers 2, 4, and 8 are used in signal and transmission formats common to terminals of an existing memory card specification.

The signal input/output portion 71 has a terminal VSS, with terminal number 1, serving as a ground terminal; a terminal BS, with terminal number 2, to which a bus state signal is input; a terminal VCC, with terminal number 3, for supplying power; a terminal SDIO, with terminal number 4, for inputting and outputting data; a terminal A0, with terminal number 5, for inputting and outputting audio data; a terminal INS, with terminal number 6, for detecting whether the wireless communication device 3 is mounted or dismounted; a terminal A1, with terminal number 7, for inputting and outputting audio data; a terminal SCLK, with terminal number 8, for inputting a clock signal; a terminal VCC, with terminal number 9, for supplying power; and a terminal VSS, with terminal number 10, serving as a ground terminal.

The wireless communication device 3 does not necessarily have to adhere to a memory card specification; for example, a wireless communication device that has been built into host equipment may also be used.

When data communication between the communication equipment 2 (2a to 2e) serving as the gateway and the host equipment 4 is performed through the wireless communication device 3 installed in the host equipment 4, data is input and output between the host equipment 4 and the communication equipment 2, between the host equipment 4 and the wireless communication device 3, and between the communication equipment 2 and the wireless communication device 3. Among these, processing, which will be described below, of the wireless communication device 3 according to the present invention refers to the input and output of data between the communication equipment 2 and the wireless communication device 3.

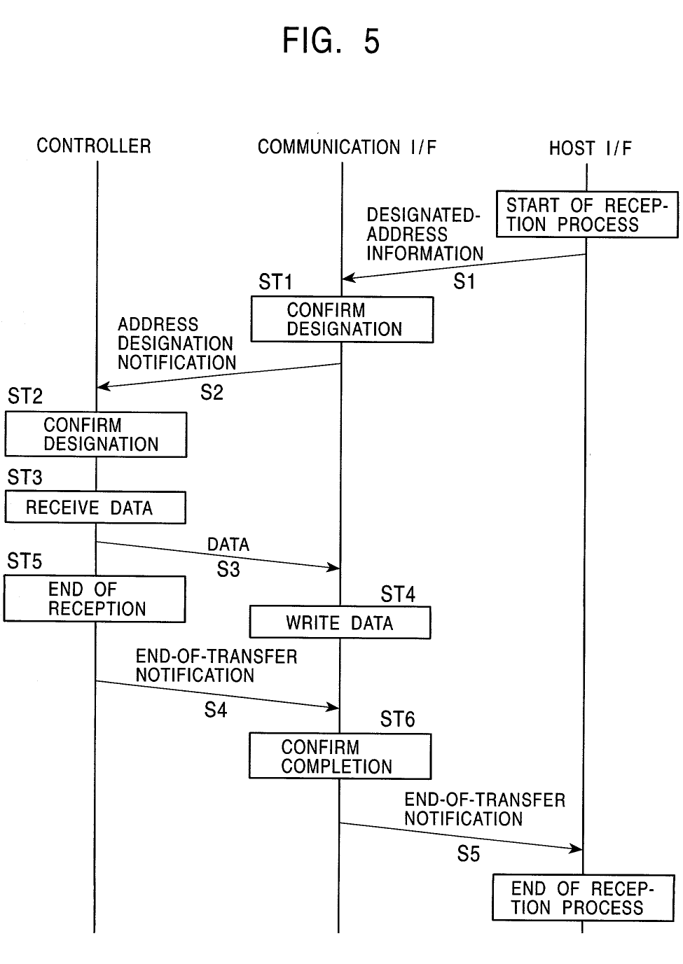

First processing in which the wireless communication device 3 receives data from the communication equipment 2 will now be described with reference to FIG. 5.

First, the host I/F 61 of the host equipment 4 outputs designated-address information Si to the communication I/F 54 of the wireless communication device 3.

The communication I/F 54 receives the designated-address information S1 from the host I/F 61, and in step ST1, confirms that an address is designated. After confirming the address designation, the communication I/F 54 outputs to the controller 53 an address-designation notification S2 for notifying the address designation.

Upon input of the address-designation notification S2 from the communication I/F 54, in step ST2, the controller 53 confirms that an address to be used for writing into the memory 55 is designated, and the process proceeds to a reception-processing mode of step ST3. In step ST3, the controller 53 receives data S3 from the communication equipment 2 through the transmitting/receiving unit 52. The controller 53 also transfers the received data S3 to the communication I/F 54.

Upon the transfer of the data S3 from the controller 53, in step ST4, the communication I/F 54 writes the data S3 into the memory 55. The address used at the time of data writing into the memory 55 is the address designated by the host equipment 4.

When the data reception from the communication equipment 2 is completed, the process proceeds to a reception-completion mode of step ST5, in which the controller 53 outputs to the communication I/F 54 an end-of-transfer notification S4 for notifying that the data transmission to the communication I/F 54 is completed. Upon receipt of the end-of-transfer notification S4, in step ST6, the communication I/F 54 ends the data writing into the memory 55. Further, the communication I/F 54 outputs an end-of-transfer notification S5 to the host I/F 61 after confirming the completion of the data writing.

In the wireless communication device 3 that performs the processing described above, a write address is designated by the host I/F 61 prior to the reception of data from the communication equipment 2. Thus, when the wireless communication device 3 receives data from the communication equipment 2 through the transmitting/receiving unit 52, a write address has already been designated by the host I/F 61. As a result, the wireless communication device 3 can directly receive data transmitted from the communication equipment 2 without inputting and outputting the data to and from the host equipment 4, because the address has already been designated by the host equipment 4. Thus, when this wireless communication device 3 is installed in host equipment in a short-range wireless communication network incorporating the 2.4-GHz Bluetooth system, it is possible to achieve prompt and efficient data transmission.

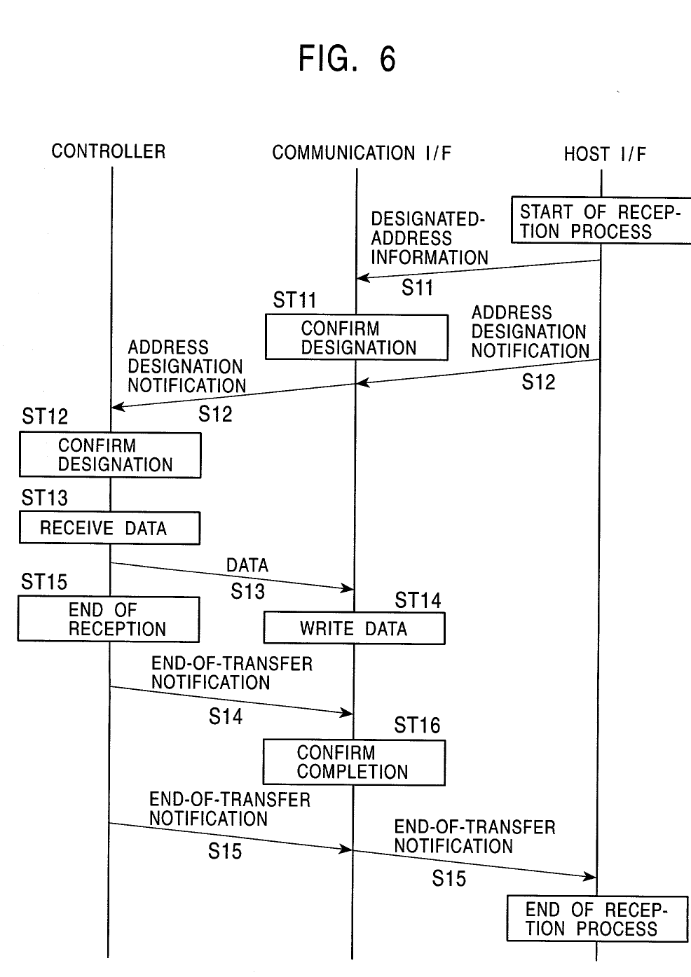

Next, second processing in which the wireless communication device 3 receives data from the communication equipment 2 will be described with reference to FIG. 6.

First, the host I/F 61 outputs designated-address information S11 to the communication I/F 54 of the wireless communication device 3.

The communication I/F 54 receives the designated-address information S11 from the host I/F 61, and in step ST11, confirms that an address is designated. The host I/F 61 of the host equipment 4 outputs an address-designation notification S12 to the controller 53 through the communication I/F 54.

Upon input of the address-designation notification S12, in step ST12, the controller 53 confirms that an address to be used for writing in the memory 55 is designated, and then process proceeds to a reception-processing mode of step ST13. In step ST13, the controller 53 receives data S13 from the communication equipment 2 through the transmitting/receiving unit 52. The controller 53 transfers the received data S13 to the communication I/F 54.

Upon the transfer of the data S13 from the controller 53, in step ST14, the communication I/F 54 writes the data S13 into the memory 55. The address used at the time of data writing into the memory 55 is the address designated by the host equipment 4.

When the controller 53 completes the data reception from the communication equipment 2, the process proceeds to a reception-completion mode in step ST15, in which the controller 53 outputs an end-of-transfer notification S14. Upon receipt of the end-of-transfer notification S14, in step ST16, the communication I/F 54 ends the data writing into the memory 55. The controller 53 outputs an end-of-transfer notification S15 to the host I/F 61 through the communication I/F 54.

The wireless communication device 3 that performs the second processing described above can output the address-designation notification S12 from the host I/F 61 to the controller 53 directly, in addition to the advantages of the wireless communication device 3 that performs the first processing for data reception described above. Moreover, the wireless communication device 3 can output the end-of-transfer notification S15 from the controller 53 to the host I/F 61 directly. This eliminates a need to provide the communication I/F 54 itself with a function for outputting the address-designation notification and the end-of-transfer notification, which can reduce the load of the wireless communication device 3 itself.

In addition, with the wireless communication device 3, the address-designation notification S12 can be output from the host I/F 61 to the controller 53 directly, in parallel with the designation confirmation after the communication I/F 54 receives the designated-address information, thereby allowing prompt processing.

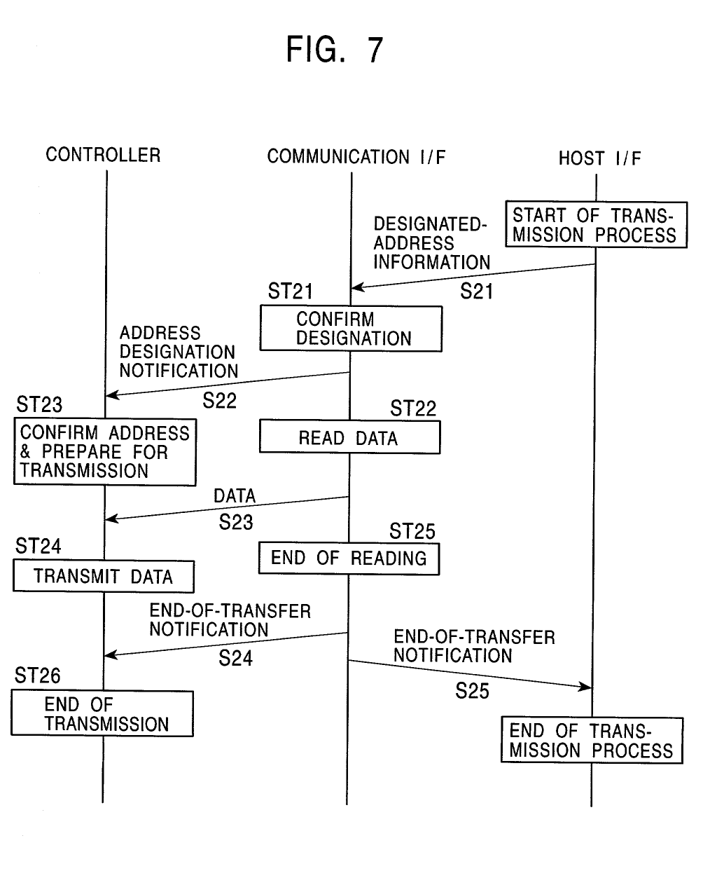

First processing in which the wireless communication device 3 transmits data to the communication equipment 2 will now be described with reference to FIG. 7.

First, the host I/F 61 outputs designated-address information S21 to the communication I/F 54 of the wireless communication device 3. The communication I/F 54 receives the designated-address information S21 from the host I/F 61, and in step ST21, confirms that an address is designated. The communication I/F 54 outputs an address-designation notification S22 to the controller 53.

Upon input of the address-designation notification S22 from the communication I/F 54, in step ST23, the controller 53 confirms that the address of data S23 to be read from the memory 55 is designated. The controller 53 also prepares to transmit the data S23 through the transmitting/receiving unit 52. After outputting the address-designation notification S22, in step ST22, the communication I/F 54 reads the data S23 from the memory 55. The address that is used at the time of reading from the memory 55 is the address designated by the host equipment 4. The communication I/F 54 transfers the read data S23 to the controller 53.

Upon the transfer of the data S23 from the communication I/F 54, the process proceeds to a transmission-processing mode of step ST24, in which the controller 53 transmits the data S23 to the communication equipment 2 through the transmitting/receiving unit 52.

When the communication I/F 54 completes reading the data S23 from the memory 55, the process proceeds to step ST25, in which the communication I/F 54 outputs an end-of-transfer notification S24 to the controller 53. The communication I/F 54 also outputs an end-of-transfer notification S25 to the host I/F 61. Upon receipt of the end-of-transfer notification S24, in step ST26, the controller 53 ends the data transmission to the communication equipment 2.

In the wireless communication device 3 that performs the processes as described above, prior to the data transmission to the communication equipment 2, a read address is designated by the host I/F 61. Thus, when the wireless communication device 3 transmits data from the communication equipment 2 through the transmitting/receiving unit 52, a read address has already been designated by the host I/F 61. As a result, the wireless communication device 3 can directly transmit the data to the communication equipment 2 without inputting and outputting the data to and from the host equipment 4, because the address is already designated by the host equipment 4. Thus, when this wireless communication device 3 is installed in host equipment in a short-range wireless communication network incorporating the 2.4-GHz Bluetooth system, it is possible to achieve prompt and efficient data transmission.

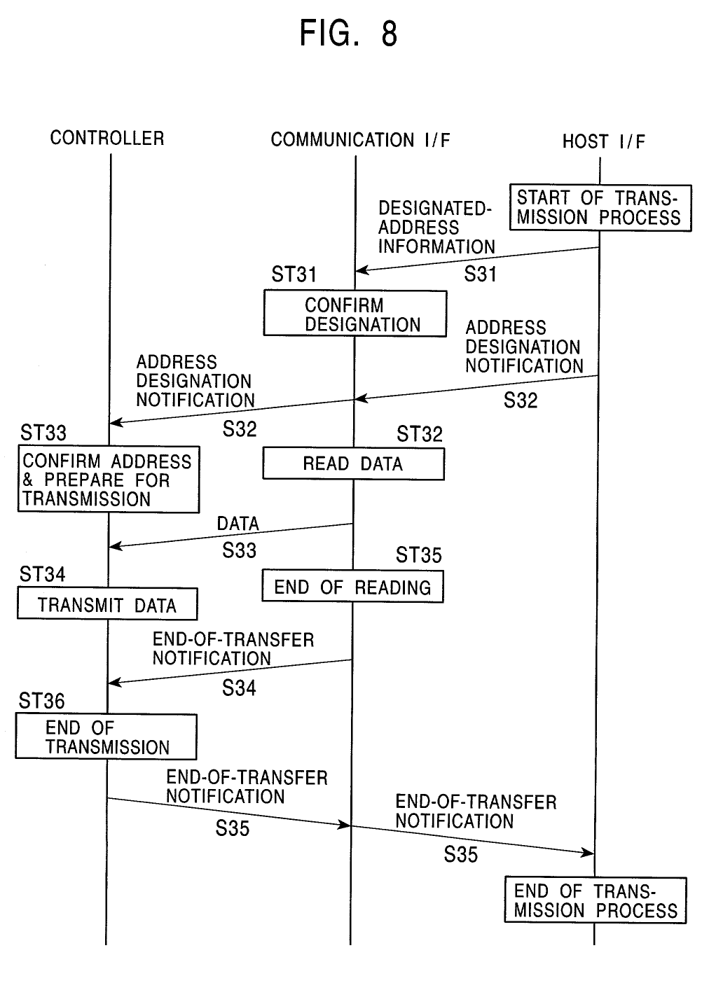

Next, second processing in which the wireless communication device 3 transmits data to the communication equipment 2 will be described with reference to FIG. 8.

First, the host I/F 61 outputs designated-address information S31 to the communication I/F 54 of the wireless communication device 3. The communication I/F 54 receives the designated-address information S31 from the host I/F 61, and in step ST31, confirms that an address is designated.

The host I/F 61 of the host equipment 4 outputs an address-designation notification S32 to the controller 53 through the communication I/F 54. Upon input of the address-designation notification S32 through the communication I/F 54, in step ST33, the controller 53 confirms that the address of data S33 to be read from the memory 55 is designated. The controller 53 also prepares to transmit the data S33 through the transmitting/receiving unit 52.

After the address-designation notification S32 is output from the host I/F 61 to the controller 63, the process proceeds to step ST32, in which the communication I/F 54 reads the data S33 from the memory 55. The address that is used at the time of reading from the memory 55 is the address designated by the host equipment 4. The communication I/F 54 transfers the read data S33 to the controller 53.

Upon the transfer of the data S33 from the communication I/F 54, the process proceeds to a transmission-processing mode in step ST34, in which the controller 53 transmits the data S33 to the communication equipment 2 through the transmitting/receiving unit 52.

When the communication I/F 54 completes reading the data from the memory 55 in step ST32, the process proceeds to step ST35, in which the communication I/F 54 outputs an end-of-transfer notification S34 to the controller 53. Upon receipt of the end-of-transfer notification S34, in step ST36, the controller 53 ends the data transmission to the communication equipment 2. At the end of the data transmission, the controller 53 outputs an end-of-transfer notification S35 to the host I/F 61 through the communication I/F 54.

The wireless communication device 3 that performs the processes described above can output the address-designation notification S32 from the host I/F 61 to the controller 53 directly, in addition to the advantages of the wireless communication device 3 that performs the first processing for data transmission described above. Moreover, the wireless communication device 3 can output the end-of-transfer notification S35 from the controller 53 to the host I/F 61 directly. This eliminates the need to provide the communication I/F 54 itself with a function for outputting the address-designation notification or the end-of-transfer notification, which can reduce the load of the wireless communication device 3 itself.

In addition, the address-designation notification S32 can be output from the host I/F 61 to the controller 53 directly, in parallel with the designation confirmation after the communication I/F 54 receives the designated-address information, thereby allowing prompt processing.

It is to be noted that the present invention is not limited to the embodiment described above. For example, the wireless communication device 3 according to the present invention is also applicable to a case in which the host equipment 4 transmits and receives data directly to and from the communication equipment 2 over the short-range wireless communication network 30. In this case, data is input and output between the communication I/F 54 and the host I/F 61 of the host equipment 4.

The wireless communication device 3 according to the present invention is also applicable to a communication network other than the short-range wireless communication network incorporating the 2.4 GHz Bluetooth system. Since the wireless communication device 3 complies with the specifications of existing removable memory cards, data other than communication data can also be stored.

What is claimed is:

1. A wireless communication device which is installed in host equipment and which performs wireless communication with other communication equipment, said wireless communication device comprising:
memory means for storing data;
wireless communication means for transmitting and receiving data to and from the other communication equipment over a wireless communication network; and
control means for controlling input and output of data between said wireless communication means and said memory means and between said wireless communication means and the host equipment,
wherein, upon receiving designated-address information for said memory means from the host equipment, said control means writes data received from the other communication equipment through said wireless communication means into the designated address or reads data to be transmitted to the other communication equipment through said wireless communication means from the designated address.

2. A wireless communication device according to claim 1, wherein said control means comprises a controller for inputting and outputting data to and from said wireless communication means and an interface for receiving the designated-address information from the host equipment, and said control means transmits and receives data to and from the other communication equipment through said wireless communication means in accordance with an address-designation notification sent from the interface.

3. A wireless communication device according to claim 1, wherein said control means comprises a controller for inputting and outputting data to and from said wireless communication means and an interface for receiving the designated-address information from the host equipment, and said control means transmits and receives data to and from the other communication equipment through said wireless communication means in accordance with an address-designation notification sent from the host equipment.

4. A wireless communication device according to claim 1, wherein after writing the data into the designated address or reading the data stored in the designated address, said control means notifies the host equipment that wireless communication is completed.

5. A wireless communication method for a wireless communication device which is installed in host equipment and which includes a wireless communication portion for transmitting and receiving data to and from other communication equipment over a wireless communication network and a memory for storing data, said wireless communication method comprising the steps of:
reading data stored in a designated address and transmitting the data to the other communication equipment upon receipt of designated-address information for the memory from the host equipment; and
writing data received from the other communication equipment into a designated address upon receipt of designated-address information for the memory from the host equipment.

6. A wireless communication method according to claim 5, wherein, upon receipt of the designated-address information for the memory from the host equipment, an address-designation notification is generated and data is transmitted and received to and from the other communication equipment through the wireless communication portion in accordance with the address-designation notification.

7. A wireless communication method according to claim 5, wherein data is transmitted and received to and from the other communication equipment through the wireless communication portion in accordance with an address-designation notification sent from the host equipment.

8. A wireless communication method according to claim 5, wherein after the data is written into the designated address or the data stored in the designated address is read, the completion of the wireless communication is notified to the host equipment.
